(19) United States
(12) Patent Application Publication
(10) Pub. No.: US 2005/0238781 A1
(43) Pub. Date: Oct. 27, 2005

(54) Ice creams comprising emulsified liquid shortening compositions comprising dietary fiber gel, water and lipid

(75) Inventors: Triveni Shukla, New Berlin, WI (US); Gregory Halpem, Vernon Hills, IL (US)

Correspondence Address: Circle Group Holdings, Inc., 1011 Campus Drive, Mundelein, IL, 60060, US

(73) Assignee: Circle Group Holdings, Inc.

(21) Appl. No.: 11/170,628

(22) Filed: Jun. 29, 2005

Related U.S. Application Data
(63) Continuation-in-part of application No. 10/689,196, filed on Oct. 20, 2003.

(51) Int. Cl. A23G 9/00

(52) U.S. Cl. 426/565

(57) ABSTRACT

According to the present invention, fat and caloric content of ice creams can be reduced by the replacement of a portion fat content normally found in ice creams with an amount of emulsified liquid shortening composition comprising amorphous insoluble cellulosic fiber gel, water and lipid. The result is that fat and caloric content of ice creams can be manipulated with minimal effect on taste and texture. Furthermore, these emulsified mixtures, or “emulsified liquid shortening compositions comprising amorphous insoluble cellulosic fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of ice creams, further health benefits can be achieved by replacing a portion of fat with emulsified liquid shortening compositions comprising amorphous insoluble cellulosic fiber gel, water and lipid.

### CROSS-REFERENCE TO RELATED APPLICATIONS

This application is a Continuation-in-Part Application of U.S. patent application Ser. No. 10/689,196, filed on Oct. 20, 2003, the entirety of which is incorporated herein.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to ice creams comprising emulsified liquid shortening compositions comprising amorphous insoluble cellulosic fiber gel, water and lipid. Recent media attention to the global problem of obesity demonstrates a need for greater availability of foods with low caloric and fat content. This is especially true for foods that typically have high fat and caloric content, such as ice creams.

Ice creams typically comprise some fat. Other ingredients can vary according to the type of ice cream and the recipe followed, but typically, ice creams are high in both fat and caloric content. It is intended that the generic term ice cream includes ice cream products such as ice cream bars, ice cream sandwiches, ice cream cakes, as well as ice milk, ice milk products, frozen yogurt, frozen yogurt products, and the like. As used in this document, the term “ice cream” is defined to include ice cream products such as ice cream bars, ice cream sandwiches, ice cream cakes, as well as ice milk, ice milk products, frozen yogurt, frozen yogurt products, and the like.

In recent years, some companies have begun to offer reduced fat ice creams. This variety of ice cream, however, often fails to retain the desirable taste and texture of ice creams comprising higher fat contents.

The absence of a means to reduce the fat and caloric content of ice creams while still producing a desirably flavored and textured ice cream presents an unmet need in today's food industry.

### BRIEF SUMMARY OF THE INVENTION

It is an object of the present invention to provide a unique composition of matter embodied by low-calorie and low-fat ice creams. This reduction in caloric and fat content answers an unmet need in the food industry to provide the consuming public with a healthier, higher fiber alternative to traditional types of ice creams that typically are inherently fattening. It is another object of the present invention to provide ice creams that have been fortified with insoluble fiber and other functional foods.

Amorphous insoluble cellulosic fiber gels for calorie reduced foods hold the key to meeting this need. Dietary fiber gels for calorie reduced foods are fully described in U.S. Pat. No. 5,766,662 (the '662 patent), which is herein incorporated by reference in its entirety. These amorphous insoluble cellulosic fiber gels comprise insoluble amorphous insoluble cellulosic fibers consisting of morphologically disintegrated cellular structures, and are characterized by their ability to retain large amounts of water. The amorphous insoluble cellulosic fiber gels are produced by shearing agricultural by-products, such as seed brans, hulls, and so forth, under alkaline conditions. Amorphous insoluble cellulosic fiber gels in a hydrated form can exist as gel, and in the dehydrated form as flakes and powders. Additionally, these amorphous insoluble cellulosic fiber gels are characterized by their high viscosities at low solid levels. Other insoluble fibers derived from cereals, grains and legumes consist of morphologically intact cellular structures, and generally are of microcrystalline form; thus they impart a gritty texture to the foods in which they are contained. The amorphous insoluble cellulosic fiber gels disclosed in the '662 patent, however, are amorphous in nature and consist of morphologically disintegrated cellular structures; they thus impart a smoother texture than other insoluble fiber formulations. The physically smooth morphology is readily revealed under electron microscopic magnification of amorphous insoluble cellulosic fiber gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

More specifically, the present invention utilizes emulsified mixtures of the amorphous insoluble cellulosic fiber gels disclosed in the '662 patent, the emulsified mixtures further comprising, at a minimum, water and lipid. These emulsified mixtures are fully described in and are the subject of U.S. patent application Ser. No. 10/669731, filed Sep. 24, 2003 which is herein incorporated by reference in its entirety. These emulsified mixtures, or “emulsified liquid shortening compositions comprising amorphous insoluble cellulosic fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of ice creams, further health benefits can be achieved by replacing a portion of fat with emulsified liquid shortening compositions comprising amorphous insoluble cellulosic fiber gel, water and lipid.

According to the present invention, fat and caloric content can be reduced by the replacement of the fat normally found in ice creams with emulsified liquid shortening compositions comprising amorphous insoluble cellulosic fiber gel, water and lipid. This replacement of fat does not adversely affect either the taste or texture of the ice creams. The result is that fat and caloric content of ice creams can be manipulated with minimal effect on taste and texture, and as stated above, additional health benefits can be achieved through consumption of ice creams comprising emulsified liquid shortening compositions comprising amorphous insoluble cellulosic fiber gel, water and lipid when functional foods are included in the formulations.

Further objects, advantages and features of the present invention will present themselves in the following detailed description.

### DETAILED DESCRIPTION OF THE PREFERRED EMBODIMENT

This invention is directed to ice creams comprising emulsified liquid shortening compositions comprising amorphous insoluble cellulosic fiber gel, water and lipid. According to the present invention, fat and caloric content can be reduced by the replacement of the fat normally found in ice creams with emulsified liquid shortening compositions comprising amorphous insoluble cellulosic fiber gel, water and lipid (hereinafter “emulsified liquid shortening”). This replacement of fat does not adversely affect either the taste or texture of the ice creams. The result is that fat and caloric content of ice creams can be manipulated with minimal effect on taste and texture.

Different categories of ice cream are available to consumers, including ice cream, ice milk, and frozen yogurt. Ice creams can be formulated such that the ice cream comprises 0.1 percent to 7.0 percent amorphous insoluble cellulosic fiber gel solids by replacing an appropriate amount, that is, an amount prorated to deliver this range of amorphous insoluble cellulosic fiber gel solids, of fat and high-fat ingredients, including milk, cream, oil and liquid shortening, with an amount of emulsified liquid shortening. Ice milk can be formulated such that the ice milk comprises 0.2 percent to 2.5 percent amorphous insoluble cellulosic fiber gel solids by replacing an appropriate amount, that is, an amount prorated to deliver this range of amorphous insoluble cellulosic fiber gel solids, of fat and high-fat ingredients, including milk, oil and liquid shortening, with an amount of emulsified liquid shortening. Frozen yogurt can be formulated such that the frozen yogurt comprises 0.1 percent to 0.75 percent amorphous insoluble cellulosic fiber gel solids by replacing an appropriate amount, that is, an amount prorated to deliver this range of amorphous insoluble cellulosic fiber gel solids, of fat and high-fat ingredients, including oil and liquid shortening, with an essentially identical amount of emulsified liquid shortening.

The result is that fat and caloric content of ice creams can be manipulated with minimal effect on taste and texture. As stated above, additional health benefits can be achieved through consumption of ice creams comprising emulsified liquid shortening compositions comprising amorphous insoluble cellulosic fiber gel, water and lipid when functional foods are included in the formulations.

### EXAMPLE 1

### Vanilla Ice Cream Comprising Emulsified Liquid Shortening Compositions Comprising Dietary Fiber Gel, Water and Lipid

TABLE 1

| | | | Low Calorie Ice | Low Calorie Ice |
|---|---|---|---|---|
| | Regular w/o | Regular with | Cream w/o | Cream with |
| Ingredient | Emulsion | Emulsion | Emulsion | Emulsion |
| Water | | 200 | | 300 |
| Milk, liter (3.5% fat) | 1150 | 800 | 1000 | 750 |
| Sugar, gram | 250 | 250 | 250 | 250 |
| Dextrose/Glucose, gram | 50 | 50 | | |
| Skim milk Powder, gram | 60 | | 250 | 300 |
| Whipping Cream, gram (32% fat) | 275 | 100 | 20 | 00 |
| Stabilizers, gram | 8 | 6.5 | 6 | 4 |
| Whole Liquid Egg | | | | |
| Z-TRIM EMULSION, gram | 0 | 100 | 00 | 70 |
| Whole Egg, 1 (65 gram) | | | 65 | 00 |
| Vanilla, ml; to spec | | | | |
| Total | 1793 | 1506.5 | 1591 | 1574 |
| Percent Fat | 7.17 | 5.58 | 3.04 | 2.74 |
| Percent Z-Trim Powder | 00 | 1.59 | 00 | 1.07 |

Four formulations of ice cream are presented in Table 1. The first formulation, labeled “Regular w/o Emulsion”, exemplifies a typical ice cream formulation for vanilla ice cream. The second ice cream formulation, labeled as “Regular with Emulsion”, demonstrates fat reduction through replacement of high-fat ingredients, namely replacing 175g of Whipping Cream and 350g Milk with 100g Emulsified Liquid Shortening Compositions Comprising Dietary Fiber Gel, Water and Lipid. The third formulation, labeled “Low Calorie Ice Cream w/o Emulsion”, demonstrates a typical low calorie ice cream formulation. The fourth formulation, labeled “Low Calorie Ice Cream with Emulsion”, demonstrates fat reduction through replacement of high-fat ingredients, namely replacing 250g milk, 20g Whipping Cream and 1 egg with 70g Emulsified Liquid Shortening Compositions Comprising Dietary Fiber Gel, Water and Lipid.

In both formulations comprising Emulsified Liquid Shortening Compositions Comprising Dietary Fiber Gel, Water and Lipid, the Emulsified Liquid Shortening, and more specifically the Dietary Fiber Gel contained therein, acts as a stabilizer, binding all unbound water in low solids. As a result, the amount of stabilizer used in the respective higher fat counterpart ice cream formulations can be decreased by the addition of the Emulsified Liquid Shortening Compositions Comprising Dietary Fiber Gel, Water and Lipid.

Addition of Emulsified Liquid Shortening Compositions Comprising Dietary Fiber Gel, Water and Lipid to ice cream formulations can result in economy products and yields products of high heat shock tolerance, longer meltdown time (longer post-serving bowl life), decreased formation of ice crystals, increased freeze-thaw stability, reduced need for other stabilizer additives, and creamy consistency. Ice cream formulations comprising Emulsified Liquid Shortening Compositions Comprising Dietary Fiber Gel, Water and Lipid are more economical than their counterpart formulations without Emulsified Liquid Shortening Compositions Comprising Dietary Fiber Gel, Water and Lipid owing to the decreased need for additional stabilizers, decrease in high-fat ingredients and improved qualities.

1. Ice cream, the ice cream having a formulation, the ice cream comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.1 percent to 7.0 percent by weight of the overall ice cream formulation, and
the emulsified liquid shortening composition comprising amorphous insoluble cellulosic fiber gel, water and lipid replaces an amount of fat used in an otherwise identical recipe of ice cream that uses no emulsified liquid shortening compositions comprising amorphous insoluble cellulosic fiber gel, water and lipid.

2. Ice milk, the ice milk having a formulation, the ice milk comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.2 percent to 2.5 percent by weight of the overall ice milk formulation, and
the emulsified liquid shortening composition comprising amorphous insoluble cellulosic fiber gel, water and lipid replaces an amount of fat used in an otherwise identical recipe of ice milk that uses no emulsified liquid shortening compositions comprising amorphous insoluble cellulosic fiber gel, water and lipid.

3. Frozen yogurt, the frozen yogurt having a formulation, the frozen yogurt comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.1 percent to 0.5 percent by weight of the overall frozen yogurt formulation, and
the emulsified liquid shortening composition comprising amorphous insoluble cellulosic fiber gel, water and lipid replaces an amount of fat used in an otherwise identical recipe of frozen yogurt that uses no emulsified liquid shortening compositions comprising amorphous insoluble cellulosic fiber gel, water and lipid.

4. A food comprising the ice cream of claim 1.

5. A food comprising the ice milk of claim 2.

6. A food comprising the frozen yogurt of claim 3.
